(19) United States
(12) Patent Application Publication
(10) Pub. No.: US 2005/0160327 A1
(43) Pub. Date: Jul. 21, 2005

(54) Input stage threshold adjustment for high speed data communications

(75) Inventors: Mashkoor Baig, Ottawa (CA); Shoujun Wang, Nepean (CA); Tad Kwasniewski, Ottawa (CA); Haitao Mei, Ottawa (CA); Bill Bereza, Nepean (CA)

Correspondence Address: FISH & NEAVE IP GROUP, ROPES & GRAY LLP, 1251 AVENUE OF THE AMERICAS FL C3, NEW YORK, NY, 10020-1105, US

(73) Assignee: Altera Corporation

(21) Appl. No.: 10/757,182

(22) Filed: Jan. 13, 2004

(51) Int. Cl. G06F 11/00

(52) U.S. Cl. 714/47

(57) ABSTRACT

Systems and methods for correcting distortions in transmitted signals are provided. More particularly, systems and methods for correcting the asymmetry that may occur between a receiver's signal-eye and a distorted signal are provided. One technique centers the signal-eye, with respect to the received signal, by adjusting the voltage threshold of the signal-eye in the receiver's clock and data recovery decision circuit. Another technique centers the signal-eye, with respect to the received signal, by shaping the voltage of the received signal. A current-mode logic circuit is provided to shape the voltage of the received signal by sinking current from the received signal.

### BACKGROUND OF THE INVENTION

This invention relates to improving the reliability of data transmissions. More particularly, this invention relates to adjusting the centering of a signal-eye in a receiver.

Data is occasionally distorted during transmission between a transmitter and receiver. Such distortions may occur as the result of, for example, noisy electronics, single-ended signal processing, PCB and package attenuation and reflection, and imperfections or mismatches in transmission lines.

Generally, a receiver's signal-eye represents the voltage threshold of a received signal that separates a logical “0” from a logical “1.” Traditionally, this voltage threshold is compared to a portion (e.g., a bit) of the received signal to determine if that portion represents a logical “1” or a logical “0.” For example, a received signal may have a logical “0” defined ideally as 0.8 volts, while a logical “1” is defined ideally as 1.2 volts. In this example, an appropriate voltage threshold may be 1 volt such that any incoming signal with a voltage below 1 volt is determined to be a logical “0”, while any incoming signal with a voltage above 1 volt is determined to be a logical “1.”

The actual comparison of a received signal to a voltage threshold traditionally occurs in a receiver's clock and data recovery (CDR) decision circuit. Here, the CDR performs a time-and-amplitude decision on a portion of a received signal in order to distinguish if that portion should be a logical “1” or a logical “0.” The CDR compares the voltage threshold (e.g., the signal-eye) to the average voltage of a received signal, which is proportional to the received signal's power, for a particular period of time (e.g., the period of time a bit is a logic LOW or a logic HIGH).

Occasionally, a signal is transmitted with multiple components. For example, a signal may be transmitted with a positive component and a negative component where the difference between the two (or the average of the two) is utilized as data. Signal distortions, however, may change the timing characteristics of these positive and negative components. For example, a receiver may be provided a negative signal component that is elongated or a positive signal component that is narrowed.

Traditional signal-eyes are stationary and focused on a point on a line intersecting the zero-crossings of a received-bit. However, if the negative and/or positive component of the received signal is skewed, then the zero-crossings for that received signal may also be skewed. Thus, the line intersecting the zero-crossings may be distorted such that the signal-eye is not centered properly with respect to the received signal. Moreover, the average voltage of the received signal, which is proportional to the signal's average power, may be distorted. These types of distortions often result in asymmetry in the received signal with respect to the receiver's signal-eye. Put another way, these types of distortions provide an off-centered signal-eye. With either problem, an incorrect voltage threshold, or asymmetry between the received signal and the signal-eye, is utilized for the received signal in the CDR. Thus, a bit may be misidentified (e.g., a logical “1” may be determined to be a logical “0” or vice versa).

Even if only a single logical “1” or “0” is misidentified, then the entire system relying on the correct identification of that bit may operate improperly or, in a worst case scenario, not operate at all.

### SUMMARY OF THE INVENTION

The present invention increases the reliability of data transmissions. More particularly, the present invention corrects an asymmetrical signal or, alternatively, an off-centered signal-eye that may occur as the result of certain types of timing distortions. Such timing distortions may include, for example, elongated and/or narrowed negative and positive signal components. Correction techniques may include adjusting the received signal with respect to the signal-eye or, alternatively, directly adjusting the signal-eye (e.g., the voltage threshold of the CDR). The object of both is to create a symmetrical signal with respect to the signal-eye or, alternatively, a centered signal-eye with respect to the received signal.

Multiple types of threshold adjust blocks are provided to correct for timing distortions in a received signal. These threshold adjust blocks provide signal-eye centering that decreases, or eliminates, the bit-error-rate (BER) for the receiver.

One type of threshold adjust block controls the amount of current in the received signal components. Using this technique, the voltage level of received signal components may be adjusted to bring symmetry to the incoming signal. Such a threshold adjust block may be advantageously employed, for example, in processing differential signals (i.e., processes where the voltage difference between two signal components is utilized as logic). Although the signal-eye voltage threshold of the CDR is not physically changed, this threshold adjust block does center the signal-eye by adjusting the received signal components so that these components are symmetrical with respect to the signal-eye.

Such a threshold adjust block may be fabricated, for example, as a current-mode logic (CML) differential stage. As a result of such a configuration, power consumption by the threshold adjust block is reduced. Moreover, the switching speed of the threshold adjustment block is increased, which, in turn, may decrease the number of signal reflections in the receiver; an attribute vital to high-speed communication transmission systems.

Another type of threshold adjust block of the present invention directly adjusts the voltage threshold utilized by the CDR. This type of threshold adjust block may be advantageously employed, for example, in a single-ended signal processing system. In this manner, the voltage threshold of the CDR may be adjusted to center the signal-eye and bring symmetry to the signal with respect to the signal-eye. Although the received signal is not physically changed, this threshold adjust block does center the signal-eye because the signal-eye is adjusted to account for the asymmetry in the received signal.

The threshold adjust blocks of the present invention may be controlled either manually or autonomously. Autonomous control of a threshold adjust block may be provided by a signal distortion detector which detects if, and by how much, the symmetry of a signal is distorted. Such a detection may be provided, for example, by comparing the peak voltage of a received signal component against an ideal peak voltage for that signal component.

Alternatively, autonomous control of the threshold adjust block may be realized by an analysis of the received signal's BER. For example, a poor BER for the received signal may trigger a circuit to autonomously adjust the signal-eye until the BER for the received signal is improved.

### BRIEF DESCRIPTION OF THE DRAWINGS

The above and other features and advantages of the present invention will be apparent upon consideration of the following detailed description, taken in conjunction with accompanying drawings, in which like reference characters refer to like parts throughout, and in which:

FIG. 1 is an illustration of a prior-art signal-eye;

FIG. 2 is an illustration of an adjustable signal-eye in accordance with the principles of the present invention;

FIG. 3 is a system topology of an illustrative receiver system employing a threshold adjust block constructed in accordance with the principles of the present invention;

FIG. 4 is a schematic of an illustrative threshold adjust block constructed in accordance with the principles of the present invention;

FIG. 5 is another schematic of an illustrative threshold adjust block constructed in accordance with the principles of the present invention;

FIG. 6 is a system topology of another illustrative receiver system employing a threshold adjust block constructed in accordance with the principles of the present invention; and

FIG. 7 is a simplified block diagram of an illustrative larger system employing circuitry in accordance with the principles of the present invention.

### DETAILED DESCRIPTION

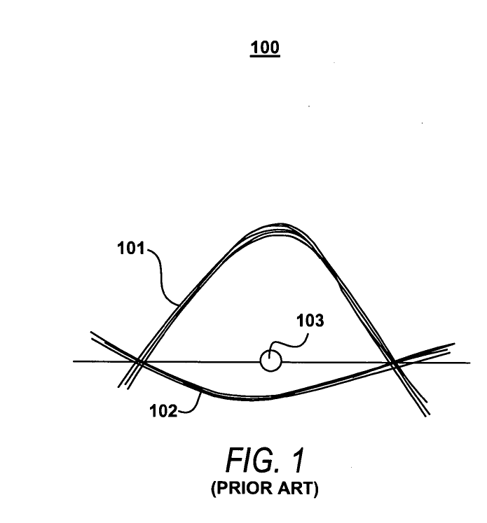

Turning first to FIG. 1, the principles of prior art signal-eye centering technique 100 is illustrated. Received positive signal component 101 and negative signal component 102 form a bit of the received signal. Signal-eye 103 is positioned vertically in-line with the zero-crossings of signal components 101 and 102. Prior art CDR circuitry (not shown) measures the average power of signal components 101 and 102 and compares them against the voltage of signal-eye 103 to determine if the received bit is a logical “1” or “0.” As stated, prior art signal-eye centering technique 100 does not correct for certain types of timing distortions. Moreover, the prior art does not provide for any correction or adjustment whatsoever.

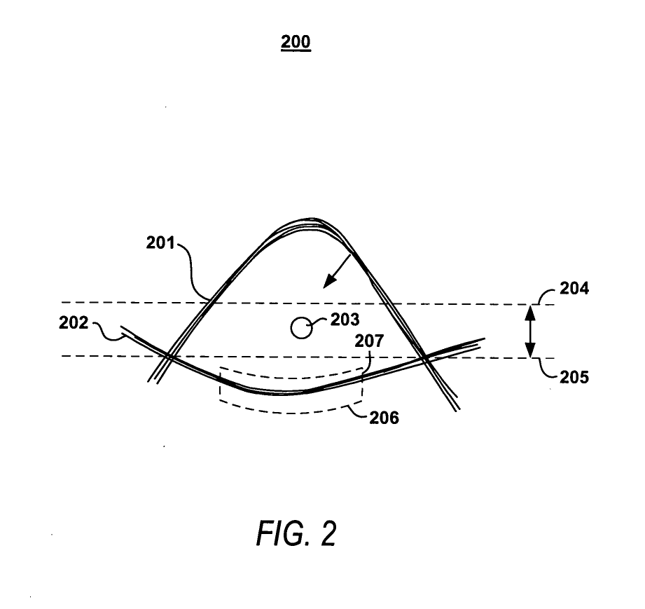

FIG. 2 illustrates the principles of signal-eye correction technique 200 constructed in accordance with the principles of the present invention. Signal-eye 203 is provided to determine if the received signal bit, defined by positive signal component 201 and negative signal component 202, is a logical “1” or “0.” As previously introduced, signal-eye 203 may be centered, with respect to the received signal bit, in a variety of ways.

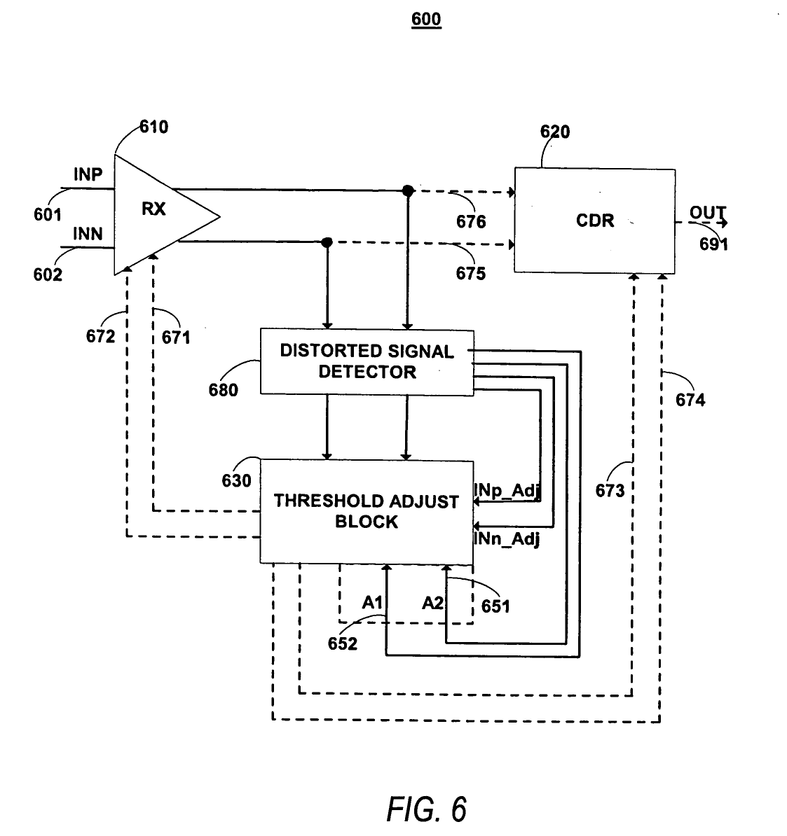

In accordance with one technique, the voltage threshold defining signal-eye 203 may be adjusted between thresholds 204 and 205, in particular pre-determined increments, to make the signal-eye symmetric with respect to the received signal. In this manner, up/down adjustments to signal-eye 203 will correct for any differences in the average power of the received signal as a result of, for example, elongated negative signal components and narrowed positive signal components. Persons skilled in the art will appreciate that signal-eye 203 may be adjusted manually. Alternatively, signal-eye 203 may be autonomously adjusted (e.g., by distortion detection circuitry 680 of FIG. 6 which is discussed in more detail below).

Using another technique, the received signal components may be directly manipulated such that signal-eye 203 is symmetric with respect to the distorted signal. For example, negative signal component 202 may be adjusted, by pre-defined intervals, between voltage curve 207 and 206. Doing so may adjust the average voltage over the period of the received bit and, therefore, may adjust the signal to conform to the positioning of signal-eye 203. The signal-eye may be thought of as a center adjustment to, for example, negative signal component 202, which normalizes negative signal component 202 to, for example, a logic LOW signal (e.g., the centering signal eye 203 is pushed upward with respect to signal components 201 and 202).

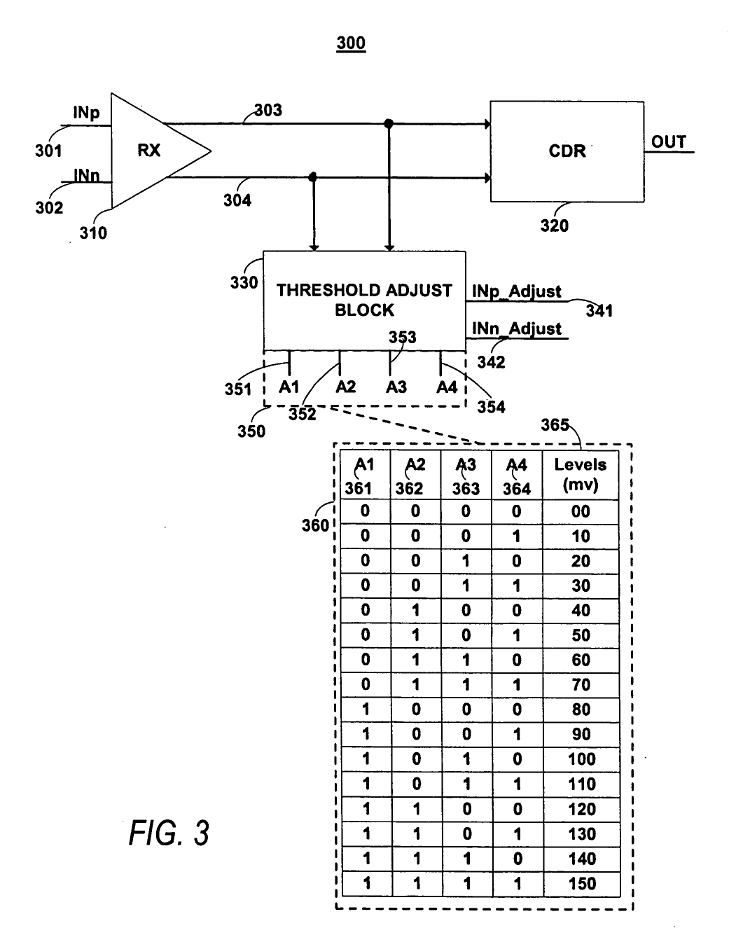

FIG. 3 shows receiver system 300 that includes receiver 310, CDR 320, and threshold adjust block 330. System 300 provides for pre-amplification (i.e., adjustment) of positive signal component 301 and negative signal component 302 before the components are utilized by CDR 320. In this manner, system 300 corrects (reshapes) any asymmetry that may be present in the received signal due to certain types of timing distortions.

Positive signal component 301 and negative signal component 302 are received by receiver 310. Receiver 310 may include additional processing circuitry such as signal amplification, decoding, conditioning, restoration or decrypting systems. For example, if signal components 301 and 302 are time division multiple access (TDMA) signals, then port 310 may include the circuitry to obtain a particular time-spaced signal from signal components 301 and 302.

Signal components 301 and 302 are routed to CDR 320, via communication lines 303 and 304, after being conditioned by receiver 310. Threshold adjust block 330 is also coupled to communication lines 303 and 304 and may, if appropriate, adjust the signal components present on these communication lines.

CDR 320 determines if the incoming bit, defined by the component signals on communication lines 303 and 304, is a logical “1” or “0.” CDR 320 compares the component signals on communication lines 303 and 304 to a threshold voltage. In one configuration, the average voltage between these signal components for a period of time may be assigned a logical “1” if such an average voltage is above the threshold voltage. Alternatively, if the average voltage of the signal components is below the threshold voltage of CDR 320, then a logical “0” may be assigned. In this manner, the threshold voltage utilized by CDR 320 may be considered a signal-eye.

As shown, threshold adjust block 330 may adjust the power levels, which adjusts the voltage levels, of the positive signal component 301 and negative signal component 302. Such an adjustment may be made either manually or autonomously. Autonomous control of threshold adjust block 330 is discussed further below with respect to FIG. 6. In adjusting the signal components provided to communication lines 303 and 304, timing distortions present in these signal components may be corrected such that the signal is symmetric with respect to the signal-eye (e.g., voltage threshold of the CDR).

Alternatively, the threshold voltage of the signal-eye may be directly adjusted. Doing so may center the signal-eye with respect to the distorted signal such that this signal is symmetric with the signal-eye.

Direct adjustment of the voltage threshold of CDR 320 will be discussed further in conjunction with the discussion of system 600 of FIG. 6. Thus, the received signal may be normalized with respect to a mean value.

Threshold adjust block 330 may include positive component adjustment control 341, negative component adjustment control 342, and voltage-step control inputs 350. Positive component adjustment control 341 and negative component adjustment control 342 determine which signal component (either positive or negative) threshold adjust block 330 adjusts. For example, a logical “1” on positive component adjustment control 341 may cause threshold adjust block 330 to step-up or step-down the voltage of the signal on communication line 303 (the positive component of the received signal). The amount, and in some embodiments the direction, of the voltage-step is determined by voltage-step control inputs 350.

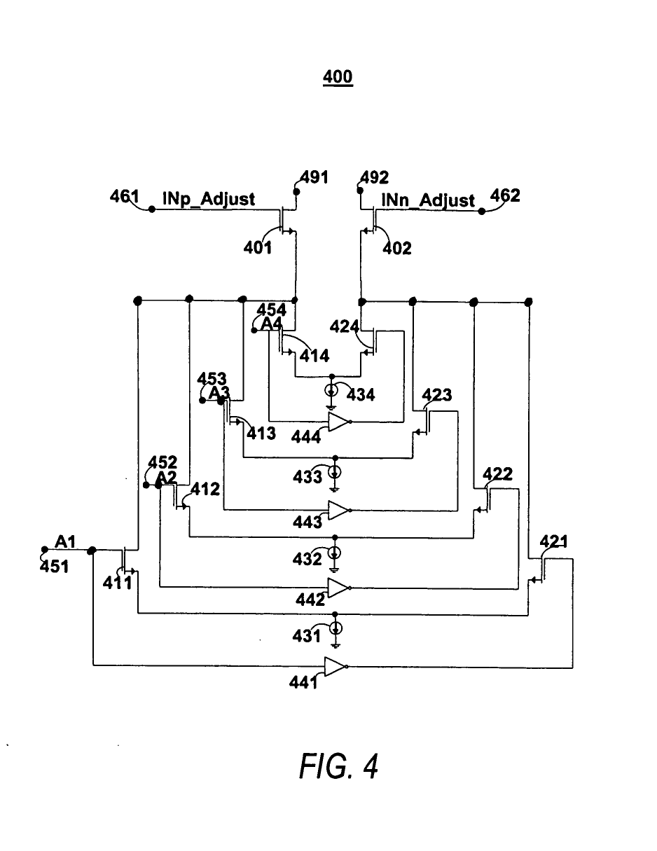

Additional inputs may be used to obtain a system with a greater resolution of voltage-steps. As shown on system 300, voltage-step control inputs 350 includes inputs 351-354. One example of possible logic for inputs 350 is shown in truth table 360 in which inputs 351-354 are associated with variables 361-364, respectively. As illustrated, truth table 360 (and related circuitry) provides voltage adjustments/corrections in 10 mv steps. The direction of these steps may be determined internally, which will be discussed further in connection with the discussion of FIG. 4.

Only one adjustment control may be employed for threshold adjust block 330 if desired. For example, a logical “1” on positive adjustment control 341 may denote an adjustment to the positive signal component, while a logical “0” on positive adjustment control 341 may denote an adjustment to the negative signal component. In some embodiments, two threshold adjust blocks 330 may be provided where each of the threshold adjust blocks 330 adjusts the positive and negative signal components in one direction. Furthermore, threshold adjust block 330 is not limited to four step-up control bits (e.g., 16 states). Topology 300 may include, for example, five step-up control bits in which the voltage of a signal may be stepped-up or stepped-down in intervals of 5 mv. In another embodiment, a single dynamic input may be used for voltage-step control inputs 350 where a particular voltage (or current) on this single dynamic input denotes a particular adjustment (e.g., where 1 mA denotes a 1 mv adjustment).

Circuit 400 of FIG. 4 includes positive component adjustment control 461 and negative component adjustment control 462 that controls when transistors 401 and 402 are ON. Voltage-step control inputs 451-454 are also included in circuit 400 and control when transistors 411-414 and 421-424 are ON. Transistors 411-414 and 421-424 may be, for example, NMOS transistor. Inverters 441-444 may be coupled between the gate terminals of transistors 411-414 and 421-424, respectively, such that a single input (e.g., input 454) can control two transistors (e.g., transistors 414 and 424) differently.

As shown, the emitter, or drain, of each one of transistors 411-414 and 421-424 may be coupled to current sources. Particularly, transistors 411-414 and 421-424 are coupled to current sources 431-434, respectively. Current sources 431-434 may each provide a different magnitude of current such that circuit 400 may adjust the received signals in particular ways.

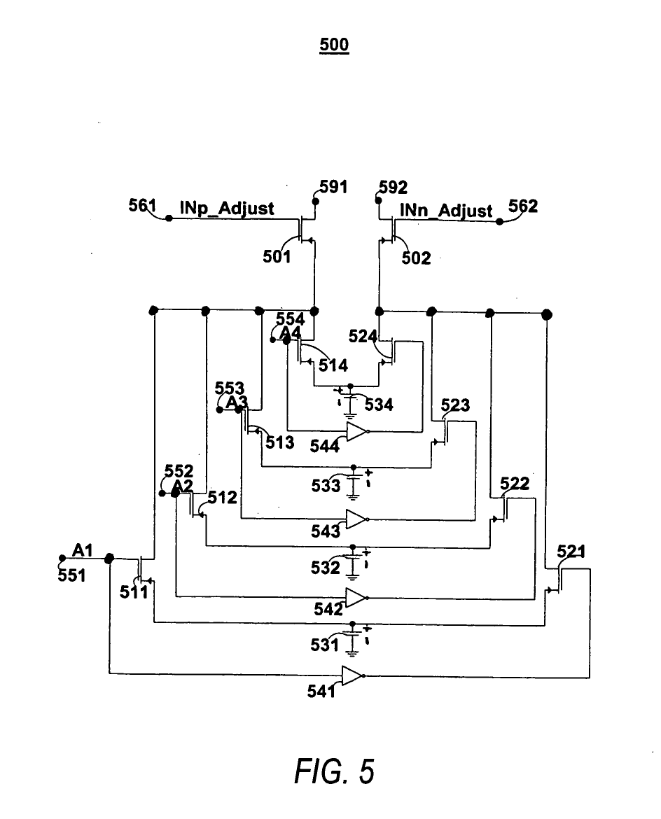

Connections 491 and 492 may each be coupled to one of communication lines 303 and 304 of FIG. 3. For example, connection 491 may be coupled to communication line 303 of FIG. 3, while connection 492 may be coupled to communication line 304 of FIG. 3. With this configuration, circuit 400 generally operates as follows. Turning ON transistor 401 electrically couples the current sources of any transistors 411-414 and 421-424 that are ON to communication line 303 of FIG. 3 via connection 491. If a current source becomes coupled to communication line 303 of FIG. 3, then the power of the positive signal component on that communication line may be forced to change. Changing the power of a signal component changes the voltage of that signal component. For example, if the total current source that is coupled to communication line 303 of FIG. 3 is greater than the current of the positive signal component, then current may “sink” into circuit 300. By decreasing the amount of current in the positive signal component, the voltage of the positive signal component decreases. Depending on the type of current source coupled to communication line 303 of FIG. 3 and the amount of current on communication line 303, the voltage of the positive signal component may be either increased or decreased. In some embodiments, two circuits 400 (or circuit 500 of FIG. 5) may be utilized in which each circuit either solely increases, or solely decreases, the voltage of the signal components.

Current sources 431-434 may be sized and matched in a variety of different configurations. For example, current sources 431-434 may each have a different voltage such that the voltage of the signal components may be stepped up/down in pre-defined evenly spaced increments (e.g., increments of 10 mv) or oddly (e.g., progressively) spaced increments (e.g., exponential increments such as 5 mv, 10 mv, 20 mv).

By correcting narrow or elongated signal components before the CDR stage, the signal-eye of the CDR stage is actually being centered with respect to the signal components. In other words, the adjustments are making the signal components symmetric with respect to the signal-eye. Thus, circuit 400 may, in some cases, elongate a narrowed signal component and narrow an elongated signal component (e.g., reshape a signal). Circuit 400 may also be utilized to directly adjust the voltage threshold of the CDR stage. For example, connection 491 may be coupled to a resistor that is, in turn, coupled to the terminal providing the threshold logic such that the voltage of this terminal may be adjusted. In a digital CDR, connections 491 and 492 may be coupled directly to a microprocessor, or other circuitry, that performs the functions of the CDR stage.

Both connections 491 and 492 may be coupled to the same signal component. For example, both connections 491 and 492 may be connected to the positive signal component on communications line 303 of FIG. 3. Separate current sources, voltage sources, or a combination of current sources and voltage sources, may be provided on the emitter terminals of each one of transistors 411-414 and 421-424. Such a configuration may allow one of transistors 401 and 402 to be responsible for increasing the voltage of the positive signal component, while the other transistor is responsible for decreasing the voltage of the positive signal component.

FIG. 5 shows circuit 500 that is similar to circuit 400 of FIG. 4 but that includes voltage sources 531-534 instead of current sources 531-534 and includes transistors 511-514 and 521-524 as PNP transistors. Thus, transistors 501 and 502 may control which of voltage sources 531-534 are coupled to connections 591 and 592. In turn, transistors 501 and 502 are controlled by control signals 561 and 562. Inputs 551-554 determine which voltage sources 531-534 are coupled to the emitter, or drain, of transistors 501 and 502 by determining which transistors 511-514 and 521-524 are ON. Circuit 400 includes inverters 541-544 between transistors 511-514 and 521-524, respectively. However, inverters 541-544 may be removed such that an additional four control signals may be provided. Circuit 500 may be utilized to adjust either the voltage threshold of the CDR or the signal components. For example, a resistor may be placed between connections 591 and 592 and communication lines 303 and 304 of FIG. 3, respectively, such that the current through communication lines 303 and 304 may be adjusted. Both techniques provide for a centered signal-eye by providing symmetry between the signal eye and the signal components.

FIG. 6 shows system 600 that includes CDR 620, receiver 610 (which receives positive signal component 601 and negative signal component 602), signal detector 680 and threshold adjust block 630. Signal detector 680 provides an autonomous adjustment feature in system 600. More particularly, distorted signal detector 680 provides the control signals to threshold adjust block 630 (e.g., voltage-step control inputs 651 and 652).

Distorted signal detector 680 may determine the control inputs provided to threshold adjust block 630 through a variety of techniques. For example, distorted signal detector 680 may compare each of the signal components against an ideal peak voltage. If the peak voltage of a signal component, for a period of time, never reaches the ideal peak voltage for that component, then distorted signal detector 680 may provide appropriate control signals to threshold adjust block 630 to correct the distortion.

To determine if the distortion has been corrected, a BER analysis may be completed by distorted signal detector 680. Such an analysis may require output signal 691. If the BER decreases as a result of an adjustment, then distorted signal detector 680 may provide appropriate signals to threshold adjust block 630 in an attempt to improve the BER even more. Alternatively, the distorted signal detector 680 may wait for a period of time to see if the BER continues to decrease. Persons skilled in the art will appreciate that the BER correction technique does not require the voltage-peak comparison technique described-above to operate and may be provided as a stand-alone technique for providing control signals to threshold adjustment block 630. Additional known distortion sensing techniques may be used either individually or in connection with a BER analysis technique.

The components of system 600 may be configured in a number of ways. For example, communication lines 676 and 675 may be removed and an adjusted signal may be provided to CDR 620 via communication lines 673 and 674. Alternatively, threshold adjust block 630 may not, for example, directly adjust the signal components but may provide control signals 671 and 672 to circuitry in receiver 610. Furthering this example, threshold adjust block 630 may provide control signals 671 and 672 to amplifiers in receiver 610 that may directly adjust the signal components. Furthermore, components of system 600 may be combined. For example, distorted signal detector 680 and threshold adjust block 630 may be one circuit or may be realized through a microprocessor. Moreover, the components of system 600 may all be included in receiver 610.

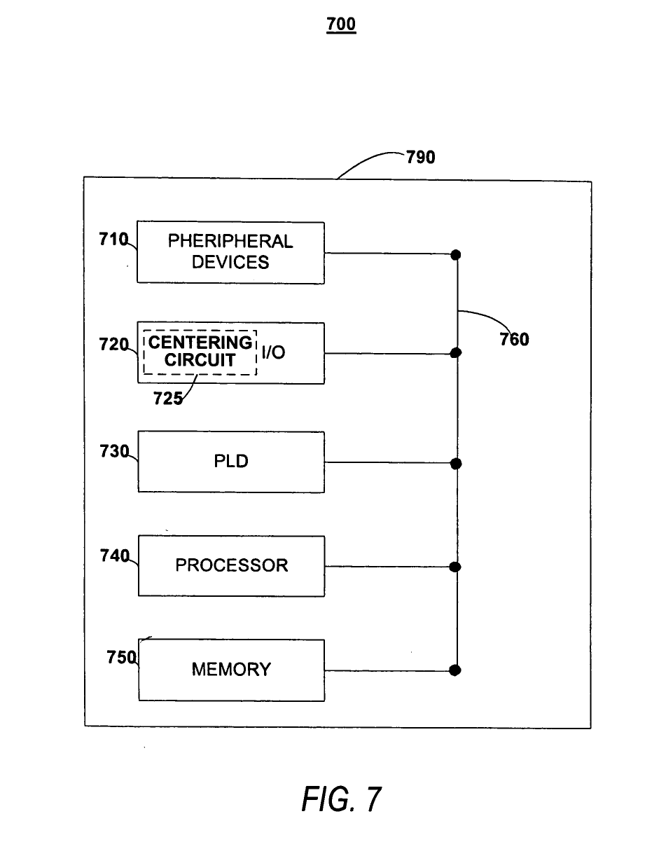

FIG. 7 shows system 700 that includes a variety of circuits located in housing 790. For example, peripheral device circuitry 710, communications circuitry 720, programmable logic device circuitry 730, processor circuitry 740, and memory 750 may be included in housing 790 and coupled together through communications network 760. The signal eye centering circuits of the present invention may be included in, for example, communications circuitry 720 in order to increase the stability and efficiency of system 700. In this manner, centering circuitry 725 may be included in communications circuitry 720. Furthermore, signal eye centering circuitry (e.g., centering circuitry 725) may be included in, or coupled to, each circuit of system 700. Thus, the circuits of system 700 may be provided outside of housing 790. Communications network 760 may be, for example, a wireless or optical communications channel.

From the foregoing description, persons skilled in the art will recognize that this invention provides systems and methods of adjusting/correcting a receiver's signal-eye. In addition, persons skilled in the art will appreciate that the various configurations described herein may be combined, or combined with other circuitry, without departing from the present invention. For example, the signal-eye of a CDR stage may be embodied as a current threshold instead of a voltage threshold. It will also be recognized that the invention may take many forms other than those disclosed in this specification. For example, the present invention may be used to adjust multiple signal-eyes for a received signal comprising multiple bits. Accordingly, it is emphasized that the invention is not limited to the disclosed methods, systems, and apparatuses, but is intended to include variations and modifications thereof which are within the spirit of the following claims.

1. A method for correcting distortions in a signal that includes logical data comprising:
receiving said signal;
comparing a portion of said signal to a signal-eye;
determining said logical data based upon said comparing;
determining said timing distortions of said portion; and
centering said signal-eye with respect to said portion based upon said determined timing distortions.

2. The method of claim 1 wherein said comparing comprises comparing a voltage threshold to said portion.

3. The method of claim 2 wherein said centering said signal-eye comprises adjusting said voltage threshold.

4. The method of claim 1 wherein said comparing further comprises comparing a current threshold to said portion.

5. The method of claim 4 wherein said centering said signal-eye comprises adjusting said current threshold.

6. The method of claim 1 wherein said centering said signal-eye comprises adjusting the voltage of said portion.

7. The method of claim 6 wherein said adjusting the voltage of said portion comprises sinking the current of said portion.

8. The method of claim 1 wherein said centering said signal-eye comprises adjusting the current of said portion.

9. The method of claim 1 wherein said portion is a bit of said logical data is defined by a positive signal component and a negative signal component and an average of said positive signal component and negative signal is compared to said signal-eye.

10. The method of claim 1 wherein said determining said distortions comprises performing a bit-error-rate analysis on said signal.

11. The method of claim 1 wherein said determining said distortions comprises comparing a peak voltage for said portion to an ideal peak voltage for said portion.

12. A system for correcting an asymmetrical signal with respect to a signal-eye comprising:
a communication channel providing said signal;
a clock and data recovery decision circuit, coupled to said communication channel, for determining the logical data included in said signal, wherein said signal-eye is compared to an average value of said signal; and
a threshold adjust block, coupled to said communication channel, for providing symmetry between said signal and said signal-eye.

13. The system of claim 12, wherein said signal-eye is a voltage threshold.

14. The system of claim 13, wherein said threshold adjust block adjusts said voltage threshold.

15. The system of claim 12, wherein said signal-eye is a current threshold.

16. The system of claim 15, wherein said threshold adjust block adjusts said current threshold.

17. The system of claim 12, wherein said threshold adjust block adjusts the voltage of said signal on said communication channel.

18. The system of claim 17, wherein said threshold adjust block decreases the voltage of said signal on said communication channel.

19. The system of claim 18, wherein said threshold adjust block decreases the voltage of said signal by sinking current from said communication channel.

20. The system of claim 12 further comprising a distorted signal detector coupled to said communications channel for detecting distortions in said signal.

21. The system of claim 20 wherein said distorted signal detector performs a bit-error-rate analysis of said logical data to detect said distortions.

22. The system of claim 20, wherein said distorted signal detector compares a peak voltage of said signal to an ideal peak voltage for said signal to detect said distortions.

23. The system of claim 20, wherein said distorted signal detector is coupled to said threshold adjust block and controls the operation of said threshold adjust block.

24. The system of claim 12, further comprising a programmable logic device coupled to said clock and data recovery circuit wherein said programmable logic device receives the logical data included in said signal.

25. A system for correcting an asymmetrical signal with respect to a signal-eye comprising:
a communication channel providing said signal; and
a threshold adjust block, coupled to said communication channel, for providing symmetry between said signal and said signal-eye, wherein said threshold adjust block adjusts said signal-eye by adjusting the amount of current in said signal.

26. The system of claim 25 wherein said threshold adjust block sinks current from said signal.

27. The system of claim 25 further comprising: a clock and data recovery decision circuit, coupled to said communication channel, for determining the logical data included in said signal, wherein said signal-eye is compared to an average value of said signal.

28. The system of claim 27 further comprising a programmable logic device coupled to said clock and data recovery circuit, wherein said programmable logic device receives the logical data included in said signal.

29. The system of claim 25 wherein said threshold adjust block is operable to adjust the current of said signal at a plurality of current amounts.

30. The system of claim 29 further comprising a plurality of control signals having a plurality of logical combinations, wherein at least one of said plurality of logical combinations sinks current from said signal by one of said plurality of current amounts.

31. The system of claim 29 further comprising a plurality of control signals having a plurality of logical combinations, wherein at least one of said plurality of logical combinations increases current from said signal by one of said plurality of current amounts.

32. The system of claim 29 further comprising a control signal that determines if the amount of current in said signal is increased or decreased.
